(19) United States
(12) Patent Application Publication
(10) Pub. No.: US 2008/0056377 A1
(43) Pub. Date: Mar. 6, 2008

(54) Neighboring Context Management

(76) Inventors: Lowell Selorio, Toronto (CA); Paul Chow, Richmond Hill (CA)

Correspondence Address: MINTZ, LEVIN, COHN, FERRIS, GLOVSKY AND POPEO, P.C, 5355 Mira Sorrento Place, Suite 600, SAN DIEGO, CA, 92121, US

(21) Appl. No.: 11/842,901

(22) Filed: Aug. 21, 2007

Related U.S. Application Data
(60) Provisional application No. 60/841,806, filed on Aug. 31, 2006.

(51) Int. Cl. H04N 7/26

(52) U.S. Cl. 375/240.25; 375/E07.027

(57) ABSTRACT

In one aspect, there is provided a system including a video decoder and a context manager. The context manager is coupled to the video decoder. The context manager may manage context information for decoding video data (e.g., macroblocks). Specifically, the context manager may prefetch context information representative of a first macroblock before a second macroblock is decoded by the video decoder. The first macroblock may be adjacent to the second macroblock. The prefetched context enables the video decoder to decode the second macroblock.

### CROSS-REFERENCE TO RELATED APPLICATION

This application claims the benefit under 35 U.S.C. Section 119(e) of the following: U.S. Provisional Patent Application No. 60/841,806, entitled “NEIGHBORING CONTEXT MANAGEMENT,” Attorney Docket No. 33609-033, filed Aug. 31, 2006, which is incorporated by reference herein.

### FIELD

The present disclosure generally relates to image processing.

### BACKGROUND

The use of video information, which may contain corresponding audio information, is already a tremendously widespread source of information and is more widespread every day. Not only is more video information used and conveyed, but the information is more complex, with more information contained in video transmissions. In addition, there is a strong desire for better video resolution in images. Along with the increases in content and resolution are completing desires for faster processing of the video information (or at least not slower processing) and for reduced cost to process the information.

To help provide video content with better resolution and/or faster processing speeds, video information may be compressed. Various video compression techniques exist, such as H.264/MPEG-4 AVC, VC-1, MPEG-2, etc. These compression techniques may reduce the amount of data analyzed by receivers, which may help the receivers process video information faster and provide better resolution in images. Some compression techniques, for example, H.264 and VC-1, use block motion compensation (BMC). Using BMC, frames are partitioned in blocks of pixels (e.g., macroblocks of 16×16 pixels in MPEG). In some forms of motion compensation, each block is predicted from a block of equal size in a reference frame; in other forms, the encoder may dynamically select the size of the blocks. The blocks are shifted to the position of the predicted block. This shift is represented by a motion vector that is encoded into the bit-stream.

### SUMMARY

The subject matter disclosed herein provides methods and apparatus, including computer program products, for providing a context manager.

In one aspect, there is provided a system including a video decoder and a context manager. The context manager is coupled to the video decoder. The context manager may manage context information for decoding video data (e.g., macroblocks). The context manager may prefetch context information representative of a first macroblock before a second macroblock is decoded by the video decoder. The first macroblock may be adjacent to the second macroblock. The prefetched context information enables the video decoder to decode the second macroblock.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE FIGURES

FIG. 1 is a block diagram of a digital video display system within a digital video playback device.

FIG. 2 is a block diagram of a context manager of a digital video decoder shown in FIG. 1.

### DETAILED DESCRIPTION

The subject matter described herein describes techniques for managing video context information, which includes information for use in deriving future image information from past image information. For example, a context manager hardware block may be implemented to interact with a video decoder to provide information to the decoder for processing video information. The context manager prefetches macroblock information for the previously decoded macroblocks adjacent to (e.g., to the left of, directly above, above and to the left, and above and to the right) a macroblock to be decoded. The context manager may also prefetch context information from previously decoded macroblocks that occupy (e.g., correspond to) the same or similar spatial position as the current macroblock but in a different frame (co-located context). The context manager provides the prefetched data to the video decoder for use by the video decoder to decode the current pixel macroblock. The context manager may organize the macroblock data and write these data to memory. The context manager may be implemented in other ways as well.

In other implementations, the subject matter described herein may provide one or more of the following capabilities. Video decompression and/or decoding (e.g., using H.264 or VC-1, AVS, MPEG-4, XVID, and DIVX) may be accelerated. Block motion compensation processing speed may be increased. Firmware may be allowed to write a number of settings to a centralized location, which may, in some implementations, reduce the number of interactions it must make with individual hardware blocks. The capability may be provided to enhance the performance of a digital video decoder through higher speed bit-rate.

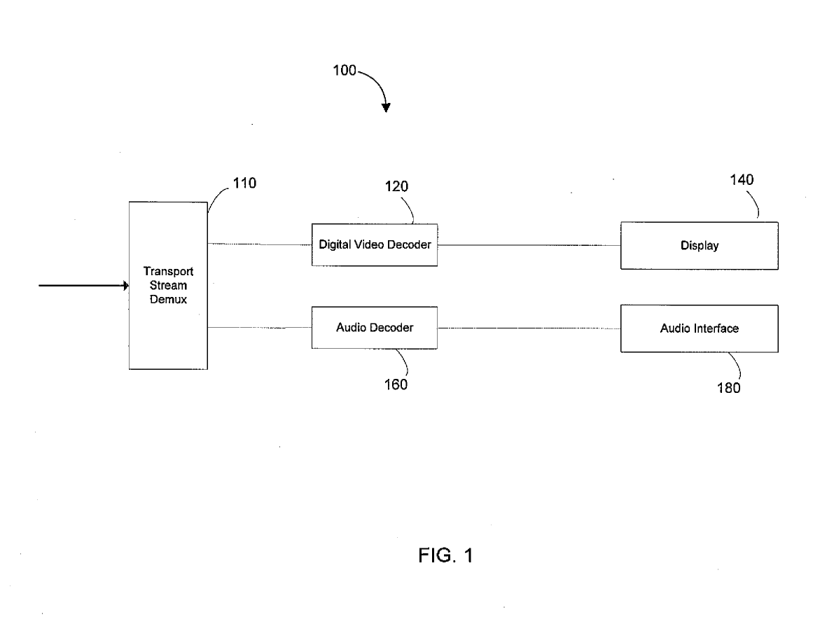

Referring to FIG. 1, a digital video display system 100 includes a transport stream demultiplexer 110, a digital video decoder 120, a video display 140, an audio decoder 160, and an audio interface 180. The transport stream demultiplexer 110 separates a single high rate digital input stream into two separate digital data streams, one for video information and one for audio information. The digital video decoder 120 is electrically connected to the demultiplexer 110 and is configured to receive the digital video stream from the demultiplexer 110. The video decoder 120 enables decompression of the digital video data stream. The video display 140 is connected to the video decoder 120 and is configured to receive the decompressed video stream, convert it to a viewable format, and display images for a viewer. The audio decoder 160 is electrically connected to the demultiplexer 110 and is configured to receive the audio data steam from the demultiplexer 110. The audio decoder 160 enables decompression of the audio information. The audio interface 180 is connected to the audio decoder 160 and is configured to receive the decompressed audio information. The audio interface then converts the decompressed audio information to sound broadcasted for listeners.

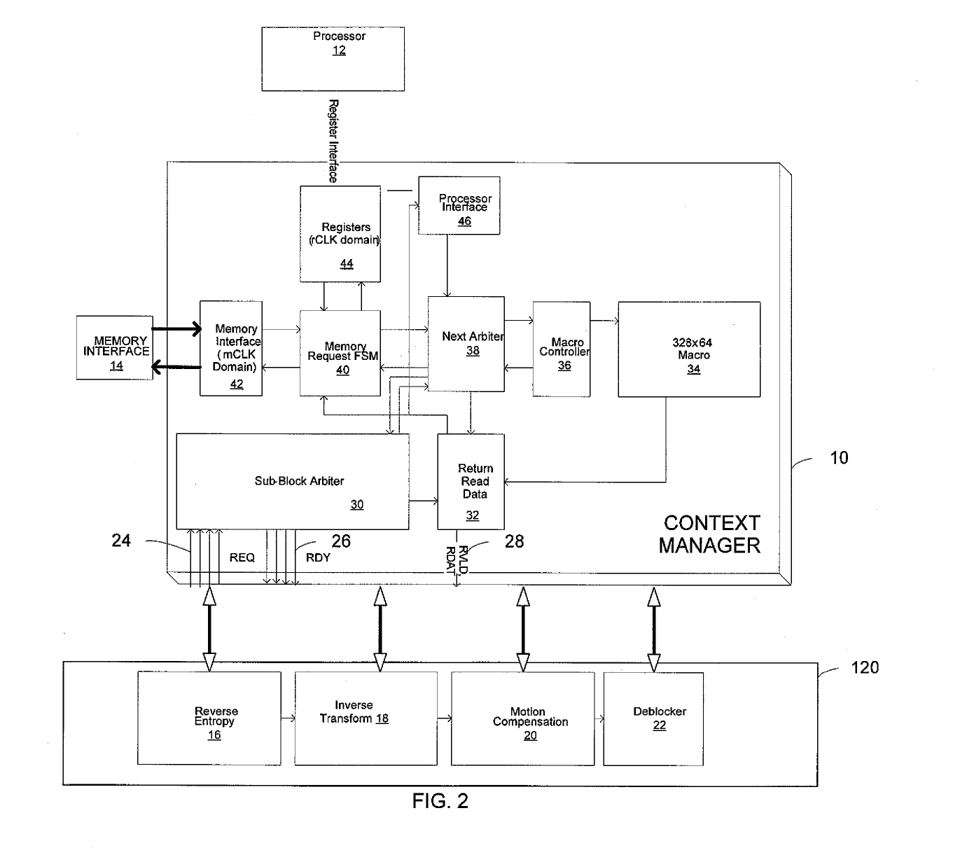

Referring also to FIG. 2, a context manage hardware block 10 is connected to the video decoder 120. The context manager 10 is, in some embodiments, hardware that may implemented in several ways in an application including, but not limited to, with a field programmable gate array (FPGA) chip, and an application specific integrated circuit (ASIC). The context manager is configured to process context data, which includes motion vectors, absolute motion vectors differentials, reference indices, context adaptive variable length coding (CAVLC) coefficients, and other data. The size and content of the context data changes depending on the standard (e.g., H.264, VC-1, etc.) and the profile of the decoded stream. The context data is primarily used while decoding future video frame pixel macroblocks. The context manager 10 includes a sub-block arbiter 30, a return read data block 32, a macro memory 34, a macro memory controller 36, a next arbiter block 38, a memory request finite state machine (FSM) 40, a memory interface 42, registers 44, and a processor interface 46. The context manager 10 is configured to interface with a processor 12 (e.g., a processor implemented in firmware, hardware, software, or any combination of thereof), a memory interface 14, and a reverse entropy block 16, an inverse transform block 18, a motion compensation block 20, and a in-loop de-blocker 22 of the video decoder 120. The context manager 10 has two primary responsibilities: pre-fetching previously written context data from the memory 14 and writing newly generated contexts to the memory 14.

For example, in the VC-1 compression technique, the context manager 10 processes bitplane data. The reverse entropy block 16 decodes the bitplane data and utilizes the macro memory 34 of the context manager 10 for temporary storage. The reverse entropy block 16 requests the context manager 10 to write the bitplane data to the memory 14. The bitplane data in the memory 14 is used by the firmware processor 12 to determine settings during the decode process, but may not be pre-fetched by the context manager 10.

The context manager 10 includes a handshaking protocol to allow it to communicate with the various stages of the video decoder 120 (e.g., blocks (also referred to as stages) 16, 18, 20 and 22 of FIG. 2). The sub-block arbiter 30 has a request input 24 and a ready indicator output 26. The request input 24 may convey requests for context data from the decode process blocks 16, 18, 20, and 22 to the context data manager 10. The ready indicator 26 may provide alerts to the video decoder 120 that the requested data are ready to be retrieved. The decode blocks 16, 18, 20, 22 may retrieve the requested data on the return valid/read data output 28 of the context manager.

One or more of the decoder blocks 16, 18, 20, 22 may make a read request at the same time and the sub-block arbiter 30 may perform traffic control functionality and decide which decoder block 16, 18, 20, 22 gets the next piece of data. The sub-block arbiter 30 also performs a traffic control functionality for the writing of data from the reverse entropy block 16, the inverse transform block 18, and the motion compensation block 20. The sub-block arbiter 30 decides which of the decoder blocks 16, 18, 20, 22 gets access to the macro memory 34. The sub-block arbiter 30 is connected to the return read data block 32 and the next arbiter block 38.

The return data block 32 is a buffer that retains information from the sub-block arbiter 30 regarding where the context data is going and transfers the context data. The return data block 32 stores the context data and transfers this data out the return valid/read data output 28. The return data block 32 may monitor the data coming from the macro memory 34. The return data block 32 is also electrically connected to the memory request FSM 40, to the next arbiter 38, and to the processor interface 46. The return read data block 32 may send the context data to the memory request FSM 40 and to the processor interface 46 and may receive context data from the next arbiter 38.

Context data is stored in a 328×64 macro memory 34 within the context manager 10. The macro memory 34 is a memory device that stores the context data going back and forth between the decoder blocks 16, 18, 20, 22 and the memory 14, and the processor 12. The internal buffer, macro memory 34 is capable of holding context data, e.g., for up to 20 macroblocks. The buffer is divided into three sections: collocation, top, and current. The size of the internal division within the buffer space will change depending on the operation of the overall decoder.

The output 28 provides an indication as to which decoder block 16, 18, 20, 22 the context data belong.

Next arbiter 38 is configured to regulate what inputs are sent to the macro memory 34. The processor 12 may also write data to the macro 34. There is often at least one piece of context data per macroblock that the processor 12 provides to the decoder blocks 16, 18, 20, 22 through the context manager 10. The memory request FSM 40 may load/write the context data out to the macro 34. Thus, the processor 12, the decoder blocks 16, 18, 20, 22, and the FSM 40 are sources of information for the macro 34. The next arbiter 38 selects a source and transmits/relays information from that source to the macro controller 36.

The macro controller 36 organizes the data bits of the information from the selected source for the macro 34. The macro controller 36 performs as an interface to the macro 34.

From the decoder blocks 16, 18, 20, 22 point of view there are two stages of arbitration. The first is a sub-block arbitration at the sub-block arbiter 30, which decides which one of the four process blocks attains access to the macro 34. The second arbitration stage is the next arbiter 38, which regulates the data traffic between the processor 12, the memory 14, and one of the four process blocks 16, 18, 20, 22 from the sub-block arbiter 30.

The memory request FSM 40 is electrically connected to the return read data block 32, the memory interface 42, registers 44, and to the next arbiter block 38 and includes a machine for reading from memory and a machine for writing to memory. While not shown in FIG. 1, a frame buffer may be coupled between the video decoder 120 and the display 140. This frame buffer is used to store the decoded images before they are displayed and for use in motion compensation. The frame buffer may be implemented as a section of memory to which the context manager 10 may read or write context data. The write machine will send the data from the current macroblock from the decoder to the memory interface 42. The read machine will fetch the data for use by the video decoder 120. The context manager 10 pre-fetches previously decoded and stored context data for a macroblock so that the context data is actually fetched from memory before the decoder blocks 16, 18, 20, 22 want to use these data. Thus, when the blocks 16, 18, 20, 22 are ready to process particular context data, these data are available from the context manager 10.

The context manager 10 monitors requests from the video decoder 120 to determine which blocks 16, 18, 20, 22 have processed and which macroblock, relative to other macroblocks in an image have been processed. The context manager 10 uses this information to determine which macroblock to pre-fetch. The context manager 10 pre-fetches context information for the macroblocks above and to the left of, immediately, directly above, above and to the right of, immediately and to the left of the macroblock to be obtained. Context data available without prefetching by the context manager 10 (e.g., the macroblock decoded immediately prior to the current macroblock) may not be prefetched by the context manager 10. The context manager 10 provides an indication to the processor 12 through the register interface 13, of the pre-fetching data status. The processor 12 starts the decoder blocks 16, 18, 20, 22 after the context manager 10 has pre-fetched the data for the top right pixel macroblock.

The context manager 10 tracks the firmware's position in the video picture and pre-fetches context data that had been previously written to memory before decoder hardware blocks 16, 18, 20, 22 desire that context data. Context data may come either from the current picture or from previously decoded video frames.

The processor 12 starts up the context manager 10 operating on the top rows of the pixel macroblock so there is no context data to pre-fetch, and the buffers are not full in an initialized state. The context manager 10 pre-fetches the top row of context data, e.g., until all the buffers of the context manager 10 are full, or until the macro memory 34 is full, or until the process has caught up the current macroblock. At time zero, the processor 12 will start the context manager 10 through the register interface 13, the registers 44, and the processor interface 46. The processor 12 will initialize/commence the decoder blocks 16, 18, 20, 22. The decoder blocks 16, 18, 20, 22 will begin writing and requesting data. The context manager 10 will write the context data from each pixel macroblock to memory 14. The context manager 10 sends the data to memory 14 through the memory request FSM block 40. The context manager 10 maintains and records information through the sub-block arbiter 30 about the request profiles of the decoder blocks 16, 18, 20, 22. The context manager 10 utilizes counter functionality that tracks the progress of the firmware processor 12 and each of the individual sub-blocks 16, 18, 20, 22 to help ensure the integrity of the data. At the end of each pixel macroblock, the decoder blocks 16, 18, 20, 22 provide indicia that they are done for this pixel macroblock. The context manager 10 writes the context data for the completed macroblocks to the memory 14. The decode process proceeds pixel macroblock after pixel macroblock from left to right, top to bottom. The context manager 10 pre-fetches the context data to be used in the second row. In bidirecitonal frames, the context manager, when needed, will prefetch the co-located motion vectors that had been computed in a previously decoded frame. The context manager 10 will provide this information to either the motion compensation block 20 or the processor block 12, depending on where the motion vectors are being calculated. As these blocks progress through the picture, the context manager 10 will progress through the co-located frame and continue to prefetch data. This process is controlled by the memory request FSM 40 and is done between fetches for top-row macroblock context data. The context manager 10 pre-fetches context data for other macroblocks in advance of the decoder beginning decoding of each macroblock.

Moreover, although the above describes particular image processing protocols as examples (e.g., H.264 and VC1). Embodiments may be used in connection any other type of image processing protocols and standards. Although the above describes a video decoder, a video encoder may also be implemented using aspects similar to those described above. Furthermore, any implementations described herein might be associated with, for example, an Application Specific integrated Circuit (ASIC) device, a processor, a video encoder, video decoder, video codec, software, hardware, and/or firmware. In addition, features implementing functions may also be physically located at various positions, including being distributed such that portions of functions are implemented at different physical locations. Furthermore, to simplify the explanation of the features of the subject matter described herein , FIGS. 1 and 2 depict simplified video decoders including only some of the sections, which may be included in a video decoder.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-along program or as a module, component, subroutine, or other unit suitable for use in a computing environment.

The foregoing description is intended to illustrate but not to limit the scope of the invention, which is defined by the scope of the appended claims. Other embodiments are within the scope of the following claims.

What is claimed:

1. A system comprising
a video decoder; and
a context manager, coupled to the video decoder, for managing context information, the context manager fetches context information representative of a first macroblock adjacent to a second macroblock being decoded by the video decoder, the fetched context information enabling the video decoder to decode the second macroblock.

2. The system of claim 1, wherein the context manager further comprises:
fetching the context information by prefetching the context information before the context information is used to decode the second macroblock.

3. The system of claim 1, wherein the context manager further comprises:
an arbiter to enable the context manager to communicate with the video decoder.

4. The system of claim 1, wherein the context manager further comprises:
an arbiter to enable the context manager to communicate with one or more of the following blocks of the video decoder; a reverse entropy block, an inverse transform block, a motion compensation block, and a deblocker block.

5. The system of claim 4, wherein the arbiter further comprises:
controlling, by the arbiter, traffic between the context manager and one or more of the following: the reverse entropy block, the inverse transform block, the motion compensation block, and the deblocker block.

6. The system of claim 5, wherein the arbiter further comprises:
controlling, by the arbiter, traffic during a read operation from the context manager to one or more of the following: the reverse entropy block, the inverse transform block, the motion compensation block, and the deblocker block.

7. The system of claim 5, wherein the arbiter further comprises:
controlling, by the arbiter, traffic using a handshaking protocol to enable the context manager to communication with one or more of the following: the reveres entropy block, the inverse transform block, the motion compensation block, and the deblocker block.

8. The system of claim 1, wherein the context manager further comprises:
a first arbiter block for controlling communication to memory of the context manager; and
a second arbiter for controlling communication among a processor, a memory interface, and one or more of the following blocks of the video decoder: a reveres entropy block, an inverse transform block, a motion compensation block, and a deblocker block.

9. The system of claim 1 further comprising:
a frame buffer coupled to the video decoder, the frame buffer storing images for use in motion compensation.

10. The system of claim 1 further comprising:
implementing the first macroblock as a data structure including data representative of pixels.

11. The system of claim 1, wherein the context manager further comprises:
a buffer for storing the context information representing one or more of the following: a motion vector, an absolute motion vector differential, reference indices, context adaptive variable length coding (CAVLC) coefficients, and inverse transform prediction modes.

12. The system of claim 1, wherein the context manager further comprises:
prefetching context information for a set of macroblocks, the prefetched context information enabling the video decoder to decode the second macroblock.

13. The system of claim 1, wherein the context manage further comprises:
implementing the context manager and the video decoder in a package comprising one or more of the following: a chip, an integrated circuit, a field programmable gate array (FPGA) chip, and an application specific integrated circuit (ASIC) chip.

14. The system of claim 1, wherein the context manager further comprises:
implementing the context manager on a package separate from another package implementing the video decoder.

15. A method comprising:
fetching, by a context manager, context information representative of a first macroblock adjacent to a second macroblock being decoded by the video decoder; and
providing the fetched context information to a video decoder to enable the video decoder to decode the second macroblock.

16. The method of claim 15, wherein fetching further comprises:
fetching the context information by prefetching the context information before the context information is used to decode the second macroblock.

17. The method of claim 15, wherein fetching further comprises:
enabling, by an arbiter, the context manager to communicate with the video decoder.

18. The method of claim 15, wherein fetching further comprises:
enabling, by an arbiter, the context manager to communicate with one or more of the following blocks of the video decoder: a reverse entropy block, an inverse transform block, a motion compensation block, and a deblocker block.

19. The method of claim 18, wherein enabling further comprises:
controlling, by the arbiter, traffic between the context manager and one or more of the following: the reverse entropy block, the inverse transform block, the motion compensation block, and the deblocker block.

20. The method of claim 19, wherein controlling further comprises:
controlling, by the arbiter, traffic during a read operation to one or more of the following: the reverse entropy block, the inverse transform block, the motion compensation block, and the deblocker block.

21. The method of claim 19, wherein controlling further comprises:
controlling, by the arbiter, traffic using a handshaking protocol to enable the context manager to communication with one or more of the following: the reverse entropy block, the inverse transform block, the motion compensation block, and the deblocker block.

22. The method of claim 15 further comprising:
controlling, at a first arbiter block, communication to memory of the context manager; and
controlling, at a second arbiter, communication among a processor, a memory interface, and one or more of the following blocks of the video decoder: a reverse entropy block, an inverse transform block, a motion compensation block, and a deblocker block.

23. The method of claim 15 further comprising:
storing, at a frame buffer coupled to the video decoder, images for use in motion compensation.

24. The method of claim 15 further comprising:
implementing the first macroblock as a data structure including data representative of pixels.

25. The method of claim 15 further comprising:
storing, at a buffer, the context information representing one or more of the following: a motion vector, an absolute motion vector differential, reference indices, context adaptive variable length coding (CAVLC) coefficients, and inverse transform prediction modes.

26. The method of claim 15 further comprising:
prefetching the context information for a set of macroblocks, the prefetched context information enabling the video decoder to decode the second macroblock.

27. The method of claim 15 further comprising:
implementing the context manager and the video decoder in a package comprising one or more of the following: a chip, an integrated circuit, a field programmable gate array (FPGA) chip, and an application specific integrated circuit (ASIC) chip.

28. The method of claim 15 further comprising:
implementing the context manager on a package separate from another package implementing the video decoder.

29. A device comprising:
a context manager for managing context information, the context manager prefetches context information for a first macroblock adjacent to a second macroblock, the context information prefetched to enable decoding of a second macroblock.

30. The device of claim 29, wherein the context manager further comprises:
an output coupled to a video decoder, the output providing the prefetched information to the video decoder.
